(19) United States
(12) Patent Application Publication
(10) Pub. No.: US 2025/0110277 A1
(43) Pub. Date: Apr. 3, 2025

(54) SYSTEMS AND METHODS FOR REDUCING SPECKLE ARTIFACTS IN LASER-ILLUMINATED PANEL DISPLAYS

(71) Applicant: Meta Platforms Technologies, LLC, Menlo Park, CA (US)

(72) Inventors: Zhujun Shi, Redmond, WA (US); Min Chul Shin, Bellevue, WA (US); Risheng Cheng, Redmond, WA (US); Steven Alexander-Boyd Hickman, Seattle, WA (US); Guohua Wei, Redmond, WA (US); Giuseppe Calafiore, Woodinville, WA (US); Zhimin Shi, Bellevue, WA (US); Lei Wang, Kirkland, WA (US)

(21) Appl. No.: 18/895,040

(22) Filed: Sep. 24, 2024

Related U.S. Application Data
(60) Provisional application No. 63/586,801, filed on Sep. 29, 2023.

(51) Int. Cl. G02B 6/28; G02B 27/48

(52) U.S. Cl. CPC G02B 6/2804; G02B 27/48

(57) ABSTRACT

The disclosed method may include receiving laser light from a laser light source. The method may also include directing and distributing the laser light onto a laser-based panel display to render pixels having a reduced spatial coherence and a preserved pixel pitch. For example, the pixels may be rendered as a result of an optical path distance between the pixels being greater than a coherent length of the laser light. Alternatively or additionally, the pixels may be rendered as a result of incoherent addition of light from at least one of multiple ports or multiple sources. Alternatively or additionally, the pixels may be rendered as a result of active modulation of the laser light. Alternatively or additionally, the pixels may be rendered as a result of quasi-random placement of outcoupling elements. Various other methods, systems, and computer-readable media are also disclosed.

### CROSS REFERENCE TO RELATED APPLICATION

This application claims the benefit of U.S. Provisional Application No. 63/586,801, filed Sep. 29, 2023, the disclosures of each of which are incorporated, in their entirety, by this reference.

### BRIEF DESCRIPTION OF DRAWINGS

The accompanying drawings illustrate a number of exemplary embodiments and are a part of the specification. Together with the following description, these appendices demonstrate and explain various principles of the present disclosure.

FIG. 1 illustrates an example laser-based panel display.

FIG. 2 illustrates an example laser illuminator for a laser-based panel display.

FIG. 3 illustrates an example interference between pixels of a laser-based panel display.

FIG. 4 illustrates an example optical path length difference between pixels as compared to the pitch of the pixels.

FIG. 5 illustrates an example interleaving for a laser-based panel display.

FIG. 6 illustrates example devices for interleaving for laser-based panel displays.

FIG. 7 illustrates example devices for interleaving for laser-based panel displays.

FIG. 8 illustrates example laser-based panel displays with cavities.

FIG. 9 illustrates example routing designs for laser-based panel displays.

FIG. 10 illustrates example devices for multiple inputs for laser-based panel displays.

FIG. 11 illustrates example implementation for multiple inputs for laser-based panel displays.

FIG. 12 illustrates example devices with active modulation for laser-based panel displays.

FIG. 13 illustrates example outcoupling element arrangements for laser-based panel displays.

FIG. 14 is a flow diagram illustrating example methods for reducing speckle artifacts in laser-illuminated panel displays.

FIG. 15 is an illustration of exemplary augmented-reality glasses that may be used in connection with embodiments of this disclosure.

FIG. 16 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

Laser-based panel displays may have various desirable properties, including a rich color gamut and a high degree of brightness. In addition, the narrowband nature of laser-based panel displays may enable a range of optical designs using diffractive and/or holographic optical elements and/or metasurfaces. However, laser-based panel displays may also have some challenges, including, e.g., coherent artifacts (i.e., image artifacts arising from unwanted light interference patterns). Such artifacts may impact the image quality as perceived by the user. In the case of augmented reality and/or virtual reality, this may form a distraction, break immersion, and/or otherwise negatively impact the user experience.

The present disclosure is generally directed to systems and methods for reducing speckle artifacts in laser-illuminated panel displays. For example, systems and methods described herein may reduce the spatial coherence of pixels while, e.g., preserving their pitch (physical distance on the panel).

In some examples, these systems and methods may reduce artifacts by increasing the optical path distance between pixels (e.g., such that the optical path distance is significantly larger than the pixel pitch). Increasing the optical path distance may be achieved through any of a variety of approaches, including the spatial interleaving of pixels and/or introducing delays into rows of pixels (e.g., using cavities and/or resonators and/or using serpentine routing layouts).

In some examples, these systems and methods may reduce artifacts through the incoherent addition of light from multiple sources. For example, these systems and methods may use multiple-port star couplers, may use multiple laser sources, may use spectrally selective dispatch circuits, and/or may use on-chip active modulation. In some examples, these systems and methods may reduce the spatial coherence of light at the display through quasi-random placements of outcouplers.

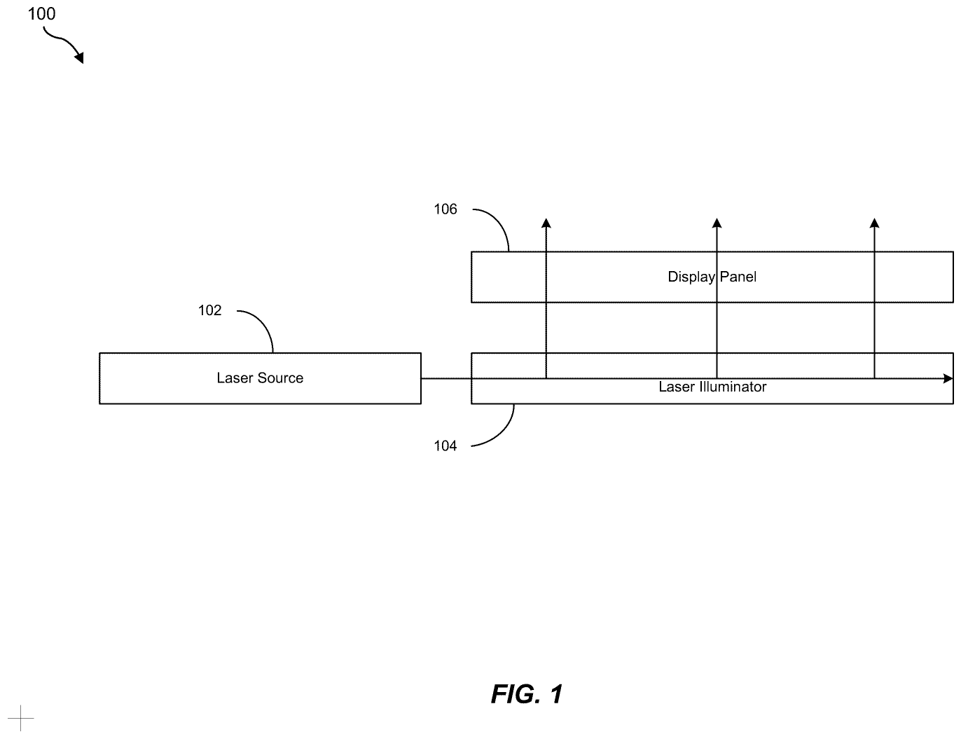

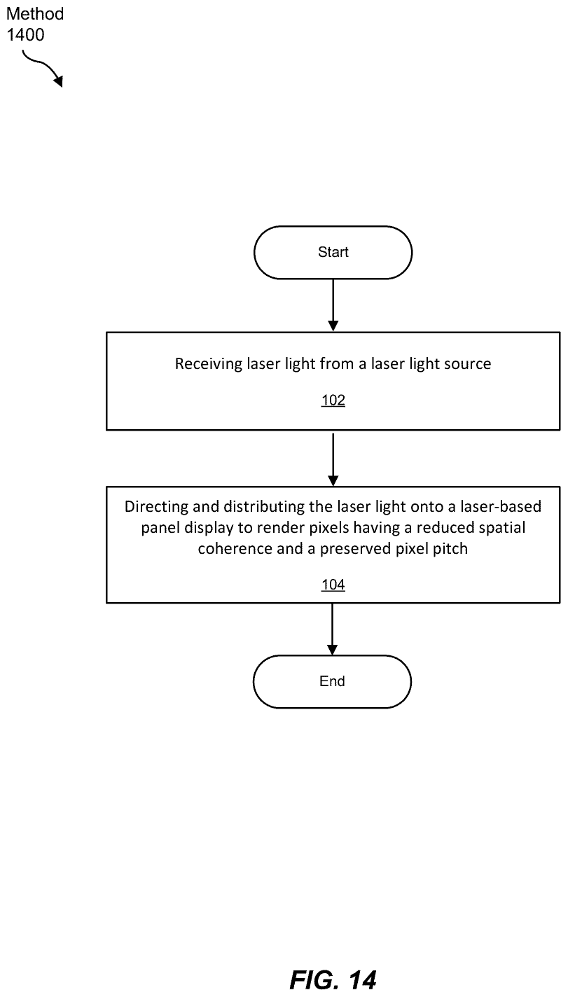

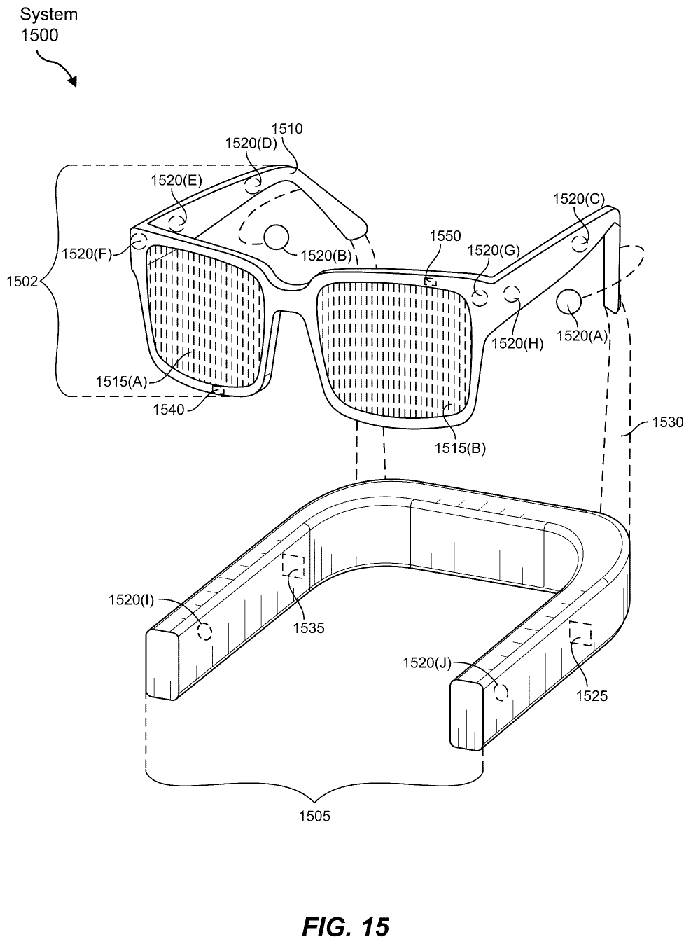

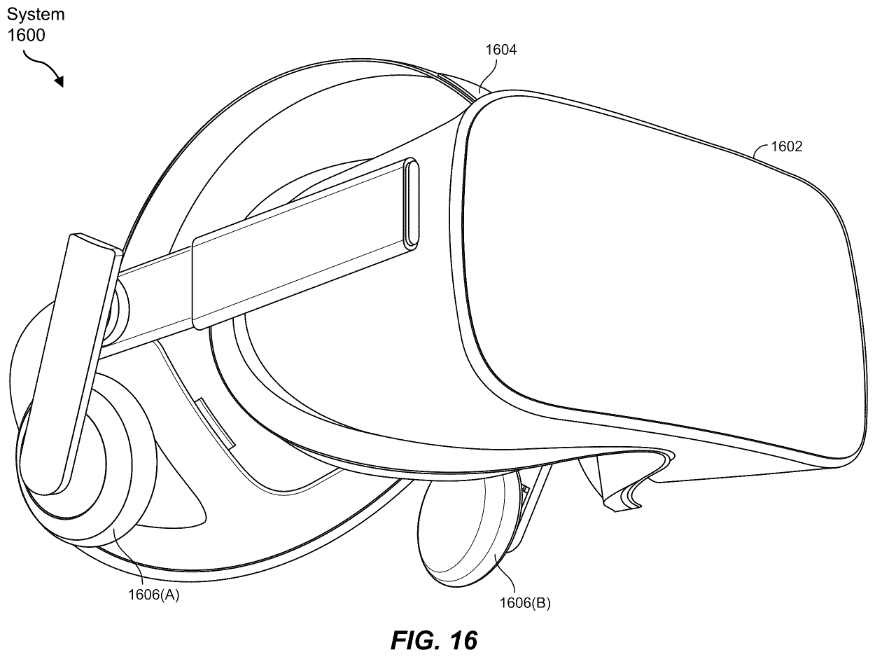

The following will provide, with reference to FIGS. 1-13, detailed descriptions of example devices and systems that reduce speckle artifacts in laser-illuminated panel displays. Detailed descriptions of example methods for reducing speckle-artifacts in laser-illuminated panel displays are provided with reference to FIG. 14. Detailed descriptions of example head mounted displays that exhibit reducing speckle-artifacts are provided with references to FIGS. 15 and 16.

FIG. 1 illustrates an example laser-based panel display 100. As shown in FIG. 1, laser-based panel display 100 may include a laser source 102, a laser illuminator 104, and a display panel 106. Laser source 102 may generate coherent light. In some examples, laser source 102 may include multiple lasers (e.g., red, green, and blue) to produce a full-color image. Laser illuminator 104 may direct and distribute light onto display panel 106. In some examples, laser illuminator 104 may include a photonic integrated circuit (PIC). Display panel 106 may include any panel suitable for laser illumination, including, without limitation, a liquid crystal display (LCD), a liquid crystal on silicon (LCoS) display, a grating light valve (GLV) display, and a digital light processing (DLP) display.

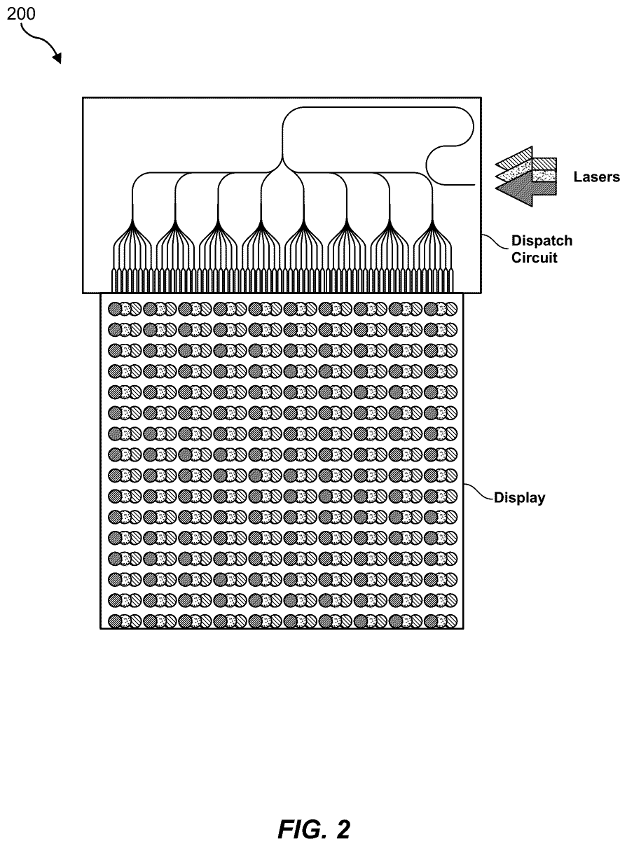

FIG. 2 illustrates an example laser illuminator 200 for a laser-based panel display. In some examples, laser illuminator 200 may correspond to laser illuminator 104 of FIG. 1.

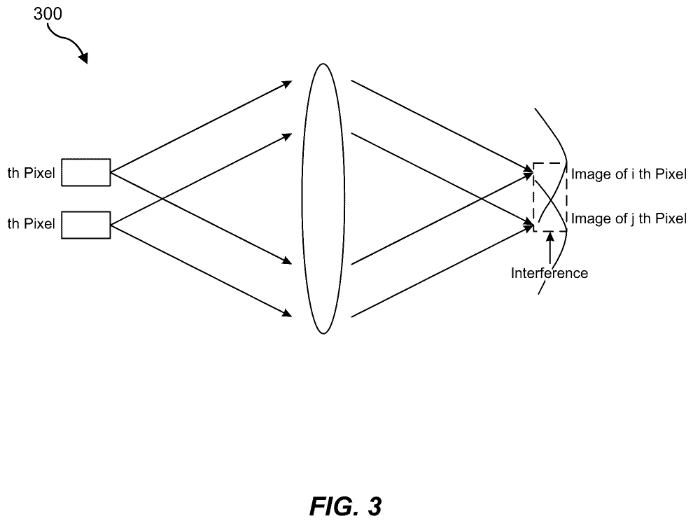

FIG. 3 illustrates an example interference 300 between pixels of a laser-based panel display. As shown in FIG. 3, a display system may include optical elements to project and/or focus an image from a display. However, the images of adjacent pixels (e.g., the ith pixel and the jth pixel) may interfere.

In some examples, coherent artifacts may be created by interference in laser-based panel displays. For example, pixels with overlapping spread functions may exhibit interference. When viewed with different eye positions, the relative phases of the interfering point spread functions may change the appearance of the interference effects. Some examples of interference may include a discrete interference pattern in the Fourier plane (e.g., that gives rise to coherent artifacts in the image which are distinctly visible to the user).

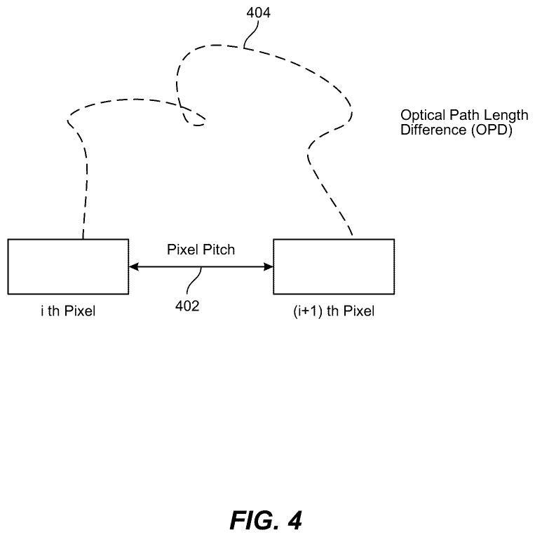

FIG. 4 illustrates an example optical path length difference between pixels as compared to the pitch of the pixels. For example, two pixels may have a pixel pitch 402 and an optical path length difference 404. Optical path length difference 404 may, in some examples, be significantly larger than pixel pitch 402. By manipulating optical path length difference 404, systems and methods described herein may reduce the spatial coherence of the pixels while preserving their physical distance on the panel. By reducing the spatial coherence of the pixels, these systems and methods may reduce the occurrence and/or intensity of coherent artifacts in the image (e.g., speckles).

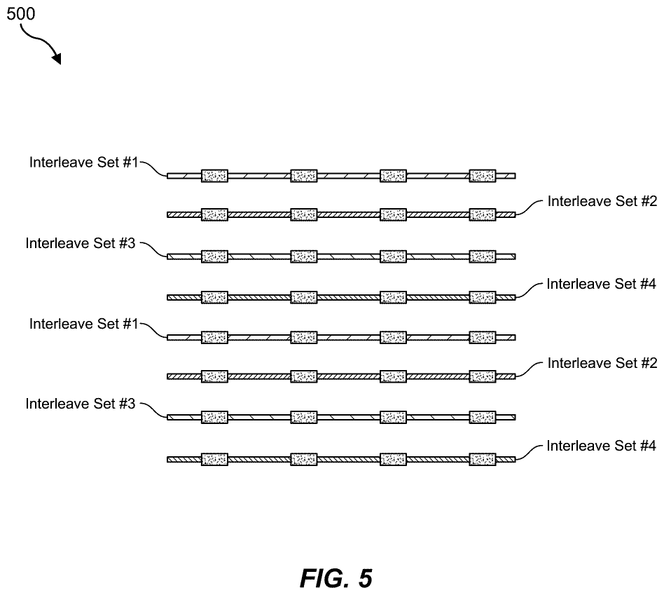

FIG. 5 illustrates an example interleaving 500 for a laser-based panel display. As shown in FIG. 5, rows of pixels may correspond to distinct interleave sets. Each interleave set may receive light from different ports (e.g., with a significantly different optical path distance between other/nearby/adjacent rows). In some examples, the difference in optical path distance may be greater than the coherent length of the laser, thereby preventing interference between rows of pixels connected to different ports. In some examples, systems described herein may include three or more distinct interleave sets. By increasing the number of distinct interleave sets, the systems described herein may increase the distance between spatially coherent pixels and may thereby reduce the speckle artifacts resulting from their point spread function overlap. In order to feed light to the rows from different ports, in some examples these systems may feed light from different sides of the rows (which technique alone may allow for two interleave sets). In some examples, these systems may employ any of a variety of other techniques, as will be explained in further detail below.

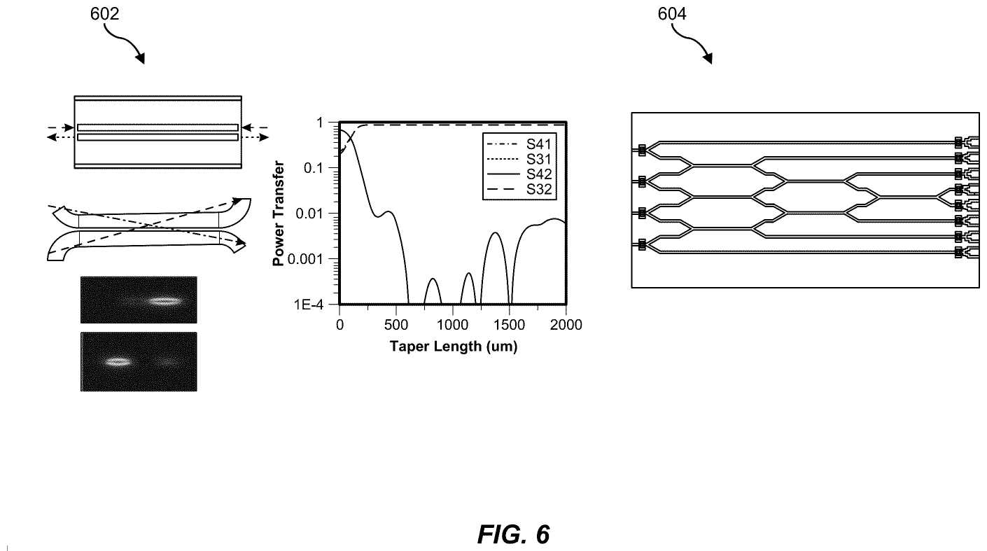

FIG. 6 illustrates example devices for interleaving for laser-based panel displays. In some examples, systems described herein may realize multiple interleaving using a single-layer photonic integrated circuit using adiabatic waveguide crossing couplers. As shown in FIG. 6, a device for interleaving for laser-based panel displays may include a waveguide crossing coupler 602. In some examples, by cascading multiple waveguide crossers, the systems described herein may achieve four, eight, or more interleaving sets. For example, layout 704 shows an example of quadruple interleaving.

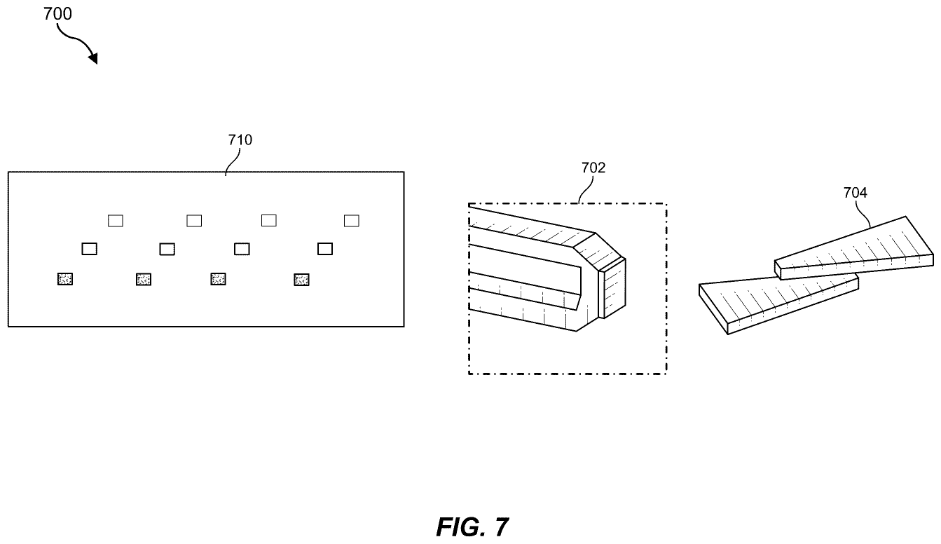

FIG. 7 illustrates example devices for interleaving for laser-based panel displays. In some examples, systems described herein may implement multiple interleaving by stacking multiple layers of photonic integrated circuits. Each layer may contain one or more interleaved sets. The different layers may be connected via vertical couplers. Examples of the vertical couplers include, without limitation, photonic vias and directional couplers. Thus, for example, FIG. 7 shows device 702 and layout 704 as examples of vertical couplers. A diagram 710 shows a large optical path difference being introduced between the different layers such that they add up incoherently on the image plane.

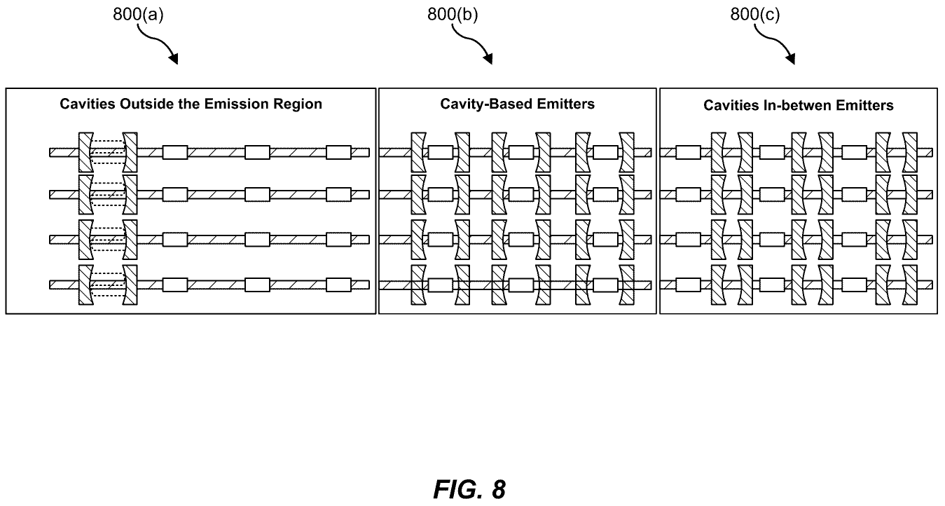

FIG. 8 illustrates example laser-based panel displays with cavities. In some examples, systems described herein may mitigate coherent artifacts via dispersion engineering. For example, these systems may employ a design whereby different wavelengths may accumulate a slightly different phase during propagation, which may be proportional to the optical path length difference. The different phase profiles of the emitter arrays may result in different far field speckle patterns. The artifacts may be suppressed if sufficiently different speckle patterns are added up.

In some examples, systems described herein may implement dispersion engineering to mitigate coherent artifacts in display images by using a source laser with a limited range of frequencies (with corresponding longitudinal modes) within its bandwidth and by providing an optical path length difference across the rows that is sufficiently large. For example, for a given bandwidth Δλ, these systems may implement an optical path length difference that is greater than (λ\hat{ }2)/Δλ such that the correlation between speckle patterns from different wavelengths is sufficiently small (i.e., the speckle patterns are sufficiently different).

In one example, systems described herein may increase delay in optical paths by using a physically longer circuit (e.g., by including more waveguide bendings). However, in various examples, in order to also maintain a low device footprint, these systems may instead (or additionally) use resonant cavities. The Q factor may be optimized to strike a balance between the transmission bandwidth and the optical delay. The cavities may be placed outside the emission region, in between the emitters, and/or inside the cavities. For example, a layout 800(a) shows cavities outside the emission region; a layout 800(b) shows cavities inside the emitters; and a layout 800(c) shows cavities in between emitters.

Any of a number of devices may implement cavities for laser-based panel displays. For example, systems described herein may use a phase-shifted Bragg grating, where distributed Bragg gratings are used as the reflectors of the cavities. In another example, systems described herein may use perturbed photonic crystal cavities. In some examples, systems described herein may use ring resonators.

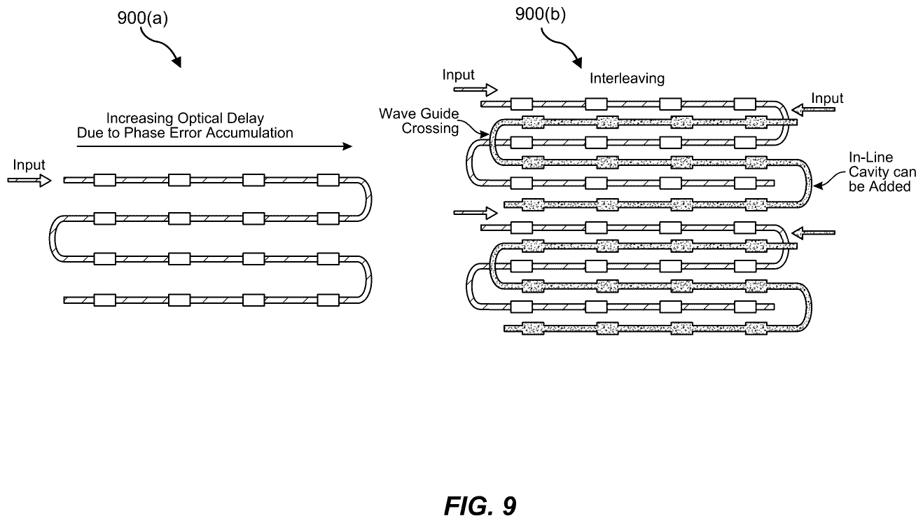

FIG. 9 illustrates example routing designs for laser-based panel displays. As shown in FIG. 9, a routing design 900(a) may use a serpentine-like routing to increase optical delay due to phase error accumulation. In some examples, systems described herein may use a serpentine routing design along with one or more other methods for reducing the spatial coherence of pixels (by, e.g., manipulating their optical path length difference). For example, these systems may use interleaving, in-line cavities, star-couplers, multiple laser sources, and/or active phase modulation. As shown in a routing design 902(a), a serpentine routing design may also include interleaving and/or in-line cavities.

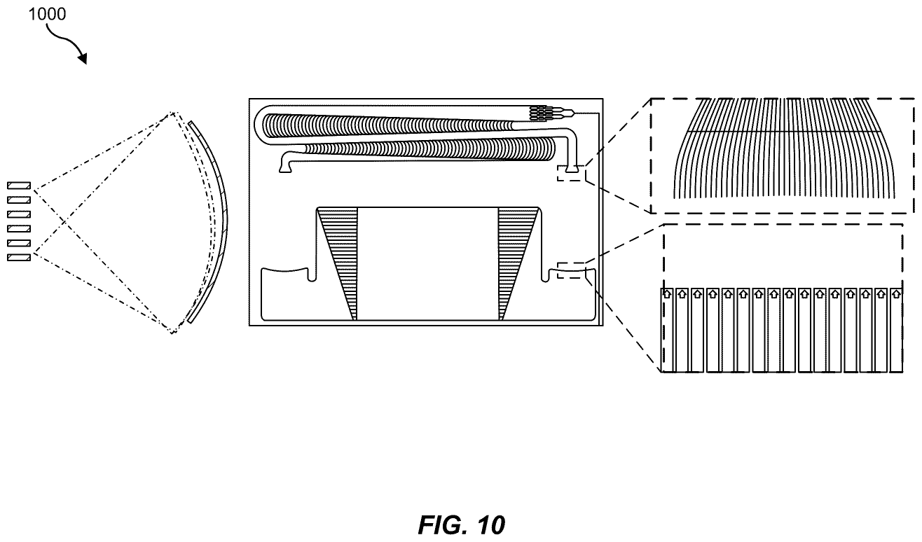

FIG. 10 illustrates example devices for multiple inputs for laser-based panel displays. In some examples, systems described herein may fed mutually incoherent input light into a photonic integrated circuit. In this manner, the resulting speckle pattern may be suppressed by 1/sqrt(N), where N is the number of incoherent inputs. The mutually incoherent inputs may be derived in any suitable manner. For example, the mutually incoherent inputs may be from different laser sources or from the same laser source but with optical path length differences greater than the coherent length. As shown in FIG. 10, devices 1000 may implement multi-port star couplers. Each row of pixels may receive light from multiple ports. The coherent artifact pattern may be averaged accordingly. The multiple ports may be connected to different laser sources or to larger delay lines. The multiple ports may be on simultaneously or turned on and off time sequentially.

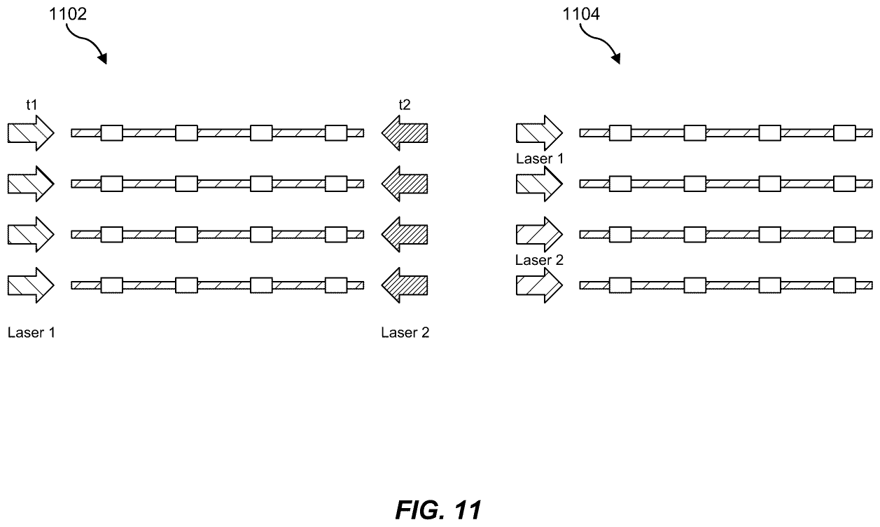

FIG. 11 illustrates example implementation for multiple inputs for laser-based panel displays. A design 1102 may use multiple sources fed through the photonic integrated circuit from opposite directions. A design 1104 may use multiple sources connected to different regions of the photonic integrated circuit.

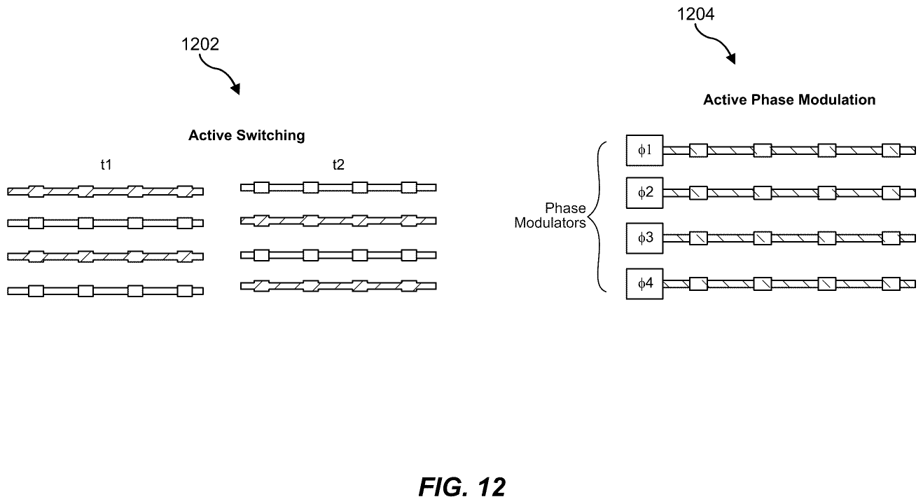

FIG. 12 illustrates example devices with active modulation for laser-based panel displays. In one example, systems described herein may reduce speckle artifacts through time averaging. For example, as shown in a device 1202, systems described herein may perform active switching; i.e., may turn on a subset of pixels at each time. This may achieve equivalent results as increasing the coherent pixel distance. In another example, as shown in a device 1204, systems described herein may implement active phase modulation; i.e., may vary the row-to-row phase profile over time. Each phase profile may generate a different speckle pattern, which may then be averaged out. The systems described herein may implement the active modulation in any of a variety of ways, including, without limitation, electro-optical modulation; thermal-optical modulation; and molecule reorientation (e.g., using liquid crystals).

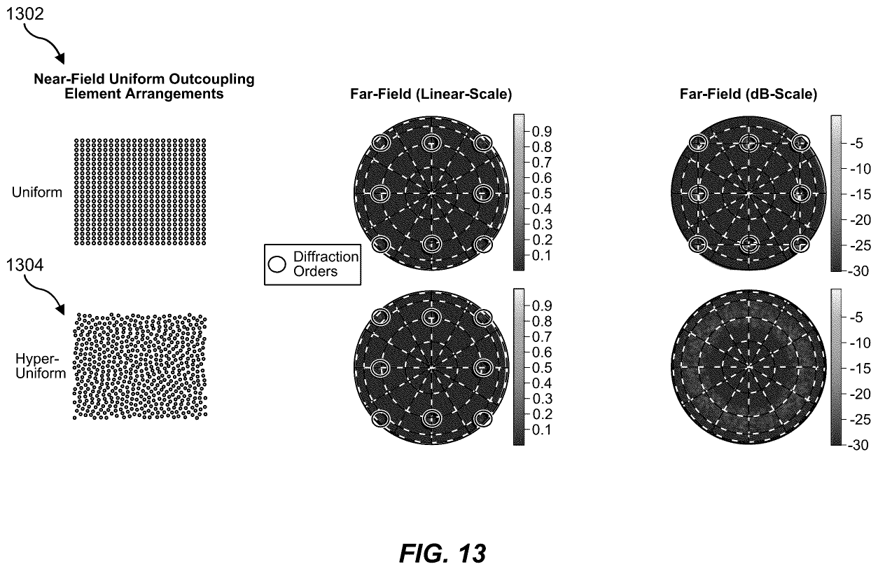

FIG. 13 illustrates example outcoupling element arrangements for laser-based panel displays. In some examples, the systems described herein may reduce the spatial coherent of pixels (while preserving emission uniformity) by placing outcoupling elements in a hyperuniform design (e.g., using a uniform distribution at a large scale and a pseudorandom distribution at a small scale). By placing outcoupling elements in a hyperuniform layout, the systems described herein may preserve uniform near-field illumination, diffraction-order free far-field illumination, and a larger distance between outcoupling elements, enabling red-green-blue integration on the same layer. Thus, FIG. 13 shows an example uniform outcoupling element arrangement 1302 and an example hyperuniform outcoupling element arrangement 1304.

FIG. 14 illustrates an example method 1400 for reducing speckle artifacts in laser-illuminated panel displays. In various implementations, method 1400 may be performed by any of the example systems and devices described above with reference to FIGS. 1-13. For example, one or more implementations of method 1400 may be performed by a display device, such as a display device that includes a laser-based panel display, a laser light source, and/or an illumination unit. In other examples, one or more implementations of method 1400 may be performed by an illumination unit, such as a photonic integrated circuit or other non-PIC systems, such as microlens-array laser backlight units.

As shown in FIG. 14, method 1400 may include receiving laser light at step 1402. For example, method 1400 may, at step 1402, include receiving laser light from a laser light source.

Method 1400 may perform step 1402 in various ways. For example, method 1400 may, at step 1402, include receiving laser light by one or more inputs (e.g., optical inputs, multiple ports, etc.) of an illumination unit. Also, method 1400 may, at step 1402, include receiving laser light in a visible spectrum (e.g., red laser light, blue laser light, green laser light, white laser light, etc.). Additionally or alternatively, method 1400 may, at step 1402, include receiving laser light from a single laser light source. Alternatively, method 1400 may, at step 1402, include receiving laser light from multiple laser light sources. In some implementations, method 1400 may, at step 1402, include receiving laser light from opposite sides or in different regions of an illumination unit. For example, an illumination unit may receive mutually incoherent inputs of the laser light from different laser sources that feed into the photonic integrated circuit from opposite directions and/or are connected to different regions of the photonic integrated circuit. In some implementations, method 1400 may, at step 1402, include receiving laser light by a single layer of the illumination unit or by multiple layers of the illumination unit. For example, multiport star couplers may configure one or more rows of pixels to receive light from multiple ports in a manner that averages a coherent artifact pattern.

As shown in FIG. 14, method 1400 may include directing and distributing laser light at step 1404. For example, method 1400 may, at step 1404, include directing and distributing the laser light onto a laser-based panel display to render pixels having a reduced spatial coherence and a preserved pixel pitch.

Method 1400 may perform step 1404 in various ways. For example, an illumination unit may, as step 1404, cause an optical path distance between the pixels to be greater than a coherent length of the laser light. Additionally or alternatively, an illumination unit may, as step 1404, exhibit incoherent addition of light from at least one of multiple ports or multiple sources. Additionally or alternatively, an illumination unit may, as step 1404, perform active modulation of the laser light. Additionally or alternatively, an illumination unit may, as step 1404, exhibit quasi-random placement of outcoupling elements.

Method 1400 may, as step 1404, cause an optical path distance between the pixels to be greater than a coherent length of the laser light in various ways that reduce the spatial coherence of the pixels while preserving the pixel pitch. For example, method 1400 may, at step 1404, perform multiple spatial interleaving of pixels in a manner that causes the optical path distance between the pixels to be greater than a coherent length of the laser light. Alternatively or additionally, method 1400 may, at step 1404, cause the optical path distance between the pixels to be greater than a coherent length of the laser light by using a number of interleaving sets that is greater than two. Alternatively or additionally, method 1400 may, at step 1404, cause the optical path distance between the pixels to be greater than a coherent length of the laser light by employing cascaded adiabatic waveguide crossing couplers that configure a single layer of a photonic integrated circuit to use more than two interleaving sets in the multiple spatial interleaving. In some of these implementations, multiple layers of a photonic integrated circuit may each contain one or more of the interleaving sets and are connected by vertical couplers. Alternatively or additionally, method 1400 may, at step 1404, cause the optical path distance between the pixels to be greater than a coherent length of the laser light because a row-to-row delay of rows of the pixels results in an optical path length difference across rows that is greater than a ratio of a square of a wavelength of the laser light and a bandwidth of the laser light source. In some of these implementations, the row-to-row delay may be achieved by resonant cavities having a Q factor that strikes a balance between a transmission bandwidth and an optical delay. In some of these implementations, the resonant cavities may correspond to at least one of phase-shifted Bragg gratings or perturbed photonic crystal cavities. In other implementations, the row-to-row delay may be achieved by serpentine routing that increases optical delay due to phase error accumulation.

Method 1400 may, as step 1404, exhibit incoherent addition of light from at least one of multiple ports or multiple sources that reduces the spatial coherence of the pixels while preserving the pixel pitch. For example, a photonic integrated circuit may receive mutually incoherent inputs of the laser light from different laser sources that at least one of feed into the photonic integrated circuit from opposite directions or are connected to different regions of the photonic integrated circuit. Alternatively or additionally, a photonic integrated circuit may receive mutually incoherent inputs of the laser light from a same laser source, and the mutually incoherent inputs may have an optical path length difference that is longer than a coherent length of the laser light. In some implementations, the incoherent addition of light may be achieved using multiport star couplers that configure one or more rows of pixels to receive light from multiple ports in a manner that averages a coherent artifact pattern. In other implementations, the incoherent addition of light may be achieved using spectrally selective dispatch circuits.

Method 1400 may, as step 1404, perform active modulation of the laser light that reduce the spatial coherence of the pixels while preserving the pixel pitch. For example, an illumination unit may perform the active modulation using active switching by turning on a subset of the pixels at a time. Alternatively or additionally, an illumination unit may perform the active modulation using phase modulation that varies a row-to-row phase profile over time.

Method 1400 may, as step 1404, employ outcoupling elements having a quasi-random placement that reduces the spatial coherence of the pixels while preserving the pixel pitch. For example, an illumination unit may have a quasi-random placement of outcoupling elements that corresponds to a hyperuniform placement of the outcoupling elements. For example, the hyperuniform placement may cause large-scale density fluctuations that simulate uniformity and small-scale density fluctuations that simulate randomness.

As set forth above, the disclosed systems and methods may reduce speckle artifacts in laser-illuminated panel displays. For example, the disclosed systems and methods may reduce the spatial coherence of pixels while, e.g., preserving their pitch (physical distance on the panel). In some examples, these systems and methods may reduce artifacts by increasing the optical path distance between pixels (e.g., such that the optical path distance is significantly larger than the pixel pitch). Increasing the optical path distance may be achieved through any of a variety of approaches, including the spatial interleaving of pixels and/or introducing delays into rows of pixels (e.g., using cavities and/or resonators and/or using serpentine routing layouts). In some examples, these systems and methods may reduce artifacts through the incoherent addition of light from multiple sources. For example, these systems and methods may use multiple-port star couplers, may use multiple laser sources, may use spectrally selective dispatch circuits, and/or may use on-chip active modulation. In some examples, these systems and methods may reduce the spatial coherence of light at the display through quasi-random placements of outcouplers.

### EXAMPLE EMBODIMENTS

Example 1: A method may include receiving laser light from a laser light source and directing and distributing the laser light onto a laser-based panel display to render pixels having a reduced spatial coherence and a preserved pixel pitch as a result of at least one of: an optical path distance between the pixels being greater than a coherent length of the laser light; incoherent addition of light from at least one of multiple ports or multiple sources; active modulation of the laser light; or quasi-random placement of outcoupling elements.

Example 2: The method of Example 1, wherein the optical path distance between the pixels is greater than the coherent length of the laser light, thereby reducing the spatial coherence of the pixels while preserving the pixel pitch.

Example 3: The method of any of Examples 1 and 2 further including performing multiple spatial interleaving of pixels in a manner that causes the optical path distance between the pixels to be greater than a coherent length of the laser light.

Example 4: The method of any of Examples 1-3, wherein a number of interleaving sets used in the multiple spatial interleaving is greater than two.

Example 5: The method of any of Examples 1-4, wherein cascaded adiabatic waveguide crossing couplers configure a single layer of a photonic integrated circuit use more than two interleaving sets in the multiple spatial interleaving.

Example 6: The method of any of Examples 1-5, wherein multiple layers of a photonic integrated circuit each contain one or more of the interleaving sets and are connected by vertical couplers.

Example 7: The method of any of Examples 1-6, wherein a row-to-row delay of rows of the pixels results in an optical path length difference across rows that is greater than a ratio of a square of a wavelength of the laser light and a bandwidth of the laser light source.

Example 8: The method of any of Examples 1-7, wherein the row-to-row delay is achieved by resonant cavities having a Q factor that strikes a balance between a transmission bandwidth and an optical delay.

Example 9: The method of any of Examples 1-8, wherein the resonant cavities correspond to at least one of phase-shifted Bragg gratings or perturbed photonic crystal cavities.

Example 10: The method of any of Examples 1-9, wherein the row-to-row delay is achieved by serpentine routing that increases optical delay due to phase error accumulation.

Example 11: The method of any of Examples 1-10, wherein the incoherent addition of light from at least one of multiple ports or multiple sources reduces the spatial coherence of the pixels while preserving the pixel pitch.

Example 12: The method of any of Examples 1-11, wherein a photonic integrated circuit receives mutually incoherent inputs of the laser light from different laser sources that at least one of feed into the photonic integrated circuit from opposite directions or are connected to different regions of the photonic integrated circuit.

Example 13: The method of any of Examples 1-12, wherein a photonic integrated circuit receives mutually incoherent inputs of the laser light from a same laser source, and the mutually incoherent inputs have an optical path length difference that is longer than a coherent length of the laser light.

Example 14: The method of any of Examples 1-13, wherein the incoherent addition of light is achieved using multiport star couplers that configure one or more rows of pixels to receive light from multiple ports in a manner that averages a coherent artifact pattern.

Example 15: The method of any of Examples 1-14, wherein the incoherent addition of light is achieved using spectrally selective dispatch circuits.

Example 16: The method of any of Examples 1-15, wherein the active modulation of the laser light reduces the spatial coherence of the pixels while preserving the pixel pitch.

Example 17: The method of any of Examples 1-16, wherein the active modulation is performed using at least one of active switching by turning on a subset of the pixels at a time or phase modulation that varies a row-to-row phase profile over time.

Example 18: The method of any of Examples 1-17, wherein the outcoupling elements have a quasi-random placement that reduces the spatial coherence of the pixels while preserving the pixel pitch, and the quasi-random placement corresponds to a hyperuniform placement of the outcoupling elements in which large-scale density fluctuations simulate uniformity and small-scale density fluctuations simulate randomness.

Example 19: A display device may include a laser-based panel display, a laser light source, and an illumination unit that receives laser light from a laser light source and directs and distributes the laser light onto the laser-based panel display to render pixels having a reduced spatial coherence and a preserved pixel pitch as a result of at least one of: an optical path distance between the pixels being greater than a coherent length of the laser light; incoherent addition of light from at least one of multiple ports or multiple sources; active modulation of the laser light; or quasi-random placement of outcoupling elements.

Example 20: A system may include at least one input configured to receive laser light from a laser light source and at least one output configured to direct and distribute the laser light onto the laser-based panel display to render pixels having a reduced spatial coherence and a preserved pixel pitch as a result of at least one of: an optical path distance between the pixels being greater than a coherent length of the laser light; incoherent addition of light from at least one of multiple ports or multiple sources; active modulation of the laser light; or quasi-random placement of outcoupling elements.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1500 in FIG. 15) or that visually immerses a user in an artificial reality (such as, e.g., virtual-reality system 1600 in FIG. 16). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 15, augmented-reality system 1500 may include an eyewear device 1502 with a frame 1510 configured to hold a left display device 1515(A) and a right display device 1515(B) in front of a user's eyes. Display devices 1515(A) and 1515(B) may act together or independently to present an image or series of images to a user. While augmented-reality system 1500 includes two displays, embodiments of this disclosure may be implemented in augmented-reality systems with a single NED or more than two NEDs.

In some embodiments, augmented-reality system 1500 may include one or more sensors, such as sensor 1540. Sensor 1540 may generate measurement signals in response to motion of augmented-reality system 1500 and may be located on substantially any portion of frame 1510. Sensor 1540 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1500 may or may not include sensor 1540 or may include more than one sensor. In embodiments in which sensor 1540 includes an IMU, the IMU may generate calibration data based on measurement signals from sensor 1540. Examples of sensor 1540 may include, without limitation, accelerometers, gyroscopes, magnetometers, other suitable types of sensors that detect motion, sensors used for error correction of the IMU, or some combination thereof.

In some examples, augmented-reality system 1500 may also include a microphone array with a plurality of acoustic transducers 1520(A)-1520(J), referred to collectively as acoustic transducers 1520. Acoustic transducers 1520 may represent transducers that detect air pressure variations induced by sound waves. Each acoustic transducer 1520 may be configured to detect sound and convert the detected sound into an electronic format (e.g., an analog or digital format). The microphone array in FIG. 15 may include, for example, ten acoustic transducers: 1520(A) and 1520(B), which may be designed to be placed inside a corresponding ear of the user, acoustic transducers 1520(C), 1520(D), 1520(E), 1520(F), 1520(G), and 1520(H), which may be positioned at various locations on frame 1510, and/or acoustic transducers 1520(I) and 1520(J), which may be positioned on a corresponding neckband 1505.

In some embodiments, one or more of acoustic transducers 1520(A)-(J) may be used as output transducers (e.g., speakers). For example, acoustic transducers 1520(A) and/or 1520(B) may be earbuds or any other suitable type of headphone or speaker.

The configuration of acoustic transducers 1520 of the microphone array may vary. While augmented-reality system 1500 is shown in FIG. 15 as having ten acoustic transducers 1520, the number of acoustic transducers 1520 may be greater or less than ten. In some embodiments, using higher numbers of acoustic transducers 1520 may increase the amount of audio information collected and/or the sensitivity and accuracy of the audio information. In contrast, using a lower number of acoustic transducers 1520 may decrease the computing power required by an associated controller 1550 to process the collected audio information. In addition, the position of each acoustic transducer 1520 of the microphone array may vary. For example, the position of an acoustic transducer 1520 may include a defined position on the user, a defined coordinate on frame 1510, an orientation associated with each acoustic transducer 1520, or some combination thereof.

Acoustic transducers 1520(A) and 1520(B) may be positioned on different parts of the user's ear, such as behind the pinna, behind the tragus, and/or within the auricle or fossa. Or, there may be additional acoustic transducers 1520 on or surrounding the ear in addition to acoustic transducers 1520 inside the ear canal. Having an acoustic transducer 1520 positioned next to an ear canal of a user may enable the microphone array to collect information on how sounds arrive at the ear canal. By positioning at least two of acoustic transducers 1520 on either side of a user's head (e.g., as binaural microphones), augmented-reality system 1500 may simulate binaural hearing and capture a 3D stereo sound field around about a user's head. In some embodiments, acoustic transducers 1520(A) and 1520(B) may be connected to augmented-reality system 1500 via a wired connection 1530, and in other embodiments acoustic transducers 1520(A) and 1520(B) may be connected to augmented-reality system 1500 via a wireless connection (e.g., a BLUETOOTH connection). In still other embodiments, acoustic transducers 1520(A) and 1520(B) may not be used at all in conjunction with augmented-reality system 1500.

Acoustic transducers 1520 on frame 1510 may be positioned in a variety of different ways, including along the length of the temples, across the bridge, above or below display devices 1515(A) and 1515(B), or some combination thereof. Acoustic transducers 1520 may also be oriented such that the microphone array is able to detect sounds in a wide range of directions surrounding the user wearing the augmented-reality system 1500. In some embodiments, an optimization process may be performed during manufacturing of augmented-reality system 1500 to determine relative positioning of each acoustic transducer 1520 in the microphone array.

In some examples, augmented-reality system 1500 may include or be connected to an external device (e.g., a paired device), such as neckband 1505. Neckband 1505 generally represents any type or form of paired device. Thus, the following discussion of neckband 1505 may also apply to various other paired devices, such as charging cases, smart watches, smart phones, wrist bands, other wearable devices, hand-held controllers, tablet computers, laptop computers, other external compute devices, etc.

As shown, neckband 1505 may be coupled to eyewear device 1502 via one or more connectors. The connectors may be wired or wireless and may include electrical and/or non-electrical (e.g., structural) components. In some cases, eyewear device 1502 and neckband 1505 may operate independently without any wired or wireless connection between them. While FIG. 15 illustrates the components of eyewear device 1502 and neckband 1505 in example locations on eyewear device 1502 and neckband 1505, the components may be located elsewhere and/or distributed differently on eyewear device 1502 and/or neckband 1505. In some embodiments, the components of eyewear device 1502 and neckband 1505 may be located on one or more additional peripheral devices paired with eyewear device 1502, neckband 1505, or some combination thereof.

Pairing external devices, such as neckband 1505, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1500 may be provided by a paired device or shared between a paired device and an eyewear device, thus reducing the weight, heat profile, and form factor of the eyewear device overall while still retaining desired functionality. For example, neckband 1505 may allow components that would otherwise be included on an eyewear device to be included in neckband 1505 since users may tolerate a heavier weight load on their shoulders than they would tolerate on their heads. Neckband 1505 may also have a larger surface area over which to diffuse and disperse heat to the ambient environment. Thus, neckband 1505 may allow for greater battery and computation capacity than might otherwise have been possible on a stand-alone eyewear device. Since weight carried in neckband 1505 may be less invasive to a user than weight carried in eyewear device 1502, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1505 may be communicatively coupled with eyewear device 1502 and/or to other devices. These other devices may provide certain functions (e.g., tracking, localizing, depth mapping, processing, storage, etc.) to augmented-reality system 1500. In the embodiment of FIG. 15, neckband 1505 may include two acoustic transducers (e.g., 1520(I) and 1520(J)) that are part of the microphone array (or potentially form their own microphone subarray). Neckband 1505 may also include a controller 1525 and a power source 1535.

Acoustic transducers 1520(I) and 1520(J) of neckband 1505 may be configured to detect sound and convert the detected sound into an electronic format (analog or digital). In the embodiment of FIG. 15, acoustic transducers 1520(I) and 1520(J) may be positioned on neckband 1505, thereby increasing the distance between the neckband acoustic transducers 1520(I) and 1520(J) and other acoustic transducers 1520 positioned on eyewear device 1502. In some cases, increasing the distance between acoustic transducers 1520 of the microphone array may improve the accuracy of beamforming performed via the microphone array. For example, if a sound is detected by acoustic transducers 1520(C) and 1520(D) and the distance between acoustic transducers 1520(C) and 1520(D) is greater than, e.g., the distance between acoustic transducers 1520(D) and 1520(E), the determined source location of the detected sound may be more accurate than if the sound had been detected by acoustic transducers 1520(D) and 1520(E).

Controller 1525 of neckband 1505 may process information generated by the sensors on neckband 1505 and/or augmented-reality system 1500. For example, controller 1525 may process information from the microphone array that describes sounds detected by the microphone array. For each detected sound, controller 1525 may perform a direction-of-arrival (DOA) estimation to estimate a direction from which the detected sound arrived at the microphone array. As the microphone array detects sounds, controller 1525 may populate an audio data set with the information. In embodiments in which augmented-reality system 1500 includes an inertial measurement unit, controller 1525 may compute all inertial and spatial calculations from the IMU located on eyewear device 1502. A connector may convey information between augmented-reality system 1500 and neckband 1505 and between augmented-reality system 1500 and controller 1525. The information may be in the form of optical data, electrical data, wireless data, or any other transmittable data form. Moving the processing of information generated by augmented-reality system 1500 to neckband 1505 may reduce weight and heat in eyewear device 1502, making it more comfortable to the user.

Power source 1535 in neckband 1505 may provide power to eyewear device 1502 and/or to neckband 1505. Power source 1535 may include, without limitation, lithium ion batteries, lithium-polymer batteries, primary lithium batteries, alkaline batteries, or any other form of power storage. In some cases, power source 1535 may be a wired power source. Including power source 1535 on neckband 1505 instead of on eyewear device 1502 may help better distribute the weight and heat generated by power source 1535.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1600 in FIG. 16, that mostly or completely covers a user's field of view. Virtual-reality system 1600 may include a front rigid body 1602 and a band 1604 shaped to fit around a user's head. Virtual-reality system 1600 may also include output audio transducers 1606(A) and 1606(B). Furthermore, while not shown in FIG. 16, front rigid body 1602 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1500 and/or virtual-reality system 1600 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1500 and/or virtual-reality system 1600 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1500 and/or virtual-reality system 1600 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A method, comprising:
receiving laser light from a laser light source; and
directing and distributing the laser light onto a laser-based panel display to render pixels having a reduced spatial coherence and a preserved pixel pitch as a result of at least one of:
an optical path distance between the pixels being greater than a coherent length of the laser light;
incoherent addition of light from at least one of multiple ports or multiple sources;
active modulation of the laser light; or
quasi-random placement of outcoupling elements.

2. The method of claim 1, wherein the optical path distance between the pixels is greater than the coherent length of the laser light, thereby reducing the spatial coherence of the pixels while preserving the pixel pitch.

3. The method of claim 2, further comprising:
performing multiple spatial interleaving of pixels in a manner that causes the optical path distance between the pixels to be greater than a coherent length of the laser light.

4. The method of claim 3, wherein a number of interleaving sets used in the multiple spatial interleaving is greater than two.

5. The method of claim 4, wherein cascaded adiabatic waveguide crossing couplers configure a single layer of a photonic integrated circuit use more than two interleaving sets in the multiple spatial interleaving.

6. The method of claim 4, wherein multiple layers of a photonic integrated circuit each contain one or more of the interleaving sets and are connected by vertical couplers.

7. The method of claim 2, wherein a row-to-row delay of rows of the pixels results in an optical path length difference across rows that is greater than a ratio of a square of a wavelength of the laser light and a bandwidth of the laser light source.

8. The method of claim 7, wherein the row-to-row delay is achieved by resonant cavities having a Q factor that strikes a balance between a transmission bandwidth and an optical delay.

9. The method of claim 8, wherein the resonant cavities correspond to at least one of phase-shifted Bragg gratings or perturbed photonic crystal cavities.

10. The method of claim 7, wherein the row-to-row delay is achieved by serpentine routing that increases optical delay due to phase error accumulation.

11. The method of claim 1, wherein the incoherent addition of light from at least one of multiple ports or multiple sources reduces the spatial coherence of the pixels while preserving the pixel pitch.

12. The method of claim 11, wherein a photonic integrated circuit receives mutually incoherent inputs of the laser light from different laser sources that at least one of feed into the photonic integrated circuit from opposite directions or are connected to different regions of the photonic integrated circuit.

13. The method of claim 11, wherein a photonic integrated circuit receives mutually incoherent inputs of the laser light from a same laser source, and the mutually incoherent inputs have an optical path length difference that is longer than a coherent length of the laser light.

14. The method of claim 11, wherein the incoherent addition of light is achieved using multiport star couplers that configure one or more rows of pixels to receive light from multiple ports in a manner that averages a coherent artifact pattern.

15. The method of claim 11, wherein the incoherent addition of light is achieved using spectrally selective dispatch circuits.

16. The method of claim 1, wherein the active modulation of the laser light reduces the spatial coherence of the pixels while preserving the pixel pitch.

17. The method of claim 16, wherein the active modulation is performed using at least one of:
active switching by turning on a subset of the pixels at a time; or
phase modulation that varies a row-to-row phase profile over time.

18. The method of claim 1, wherein the outcoupling elements have a quasi-random placement that reduces the spatial coherence of the pixels while preserving the pixel pitch, and the quasi-random placement corresponds to a hyperuniform placement of the outcoupling elements in which large-scale density fluctuations simulate uniformity and small-scale density fluctuations simulate randomness.

19. A display device, comprising:
a laser-based panel display;
a laser light source; and
an illumination unit that receives laser light from a laser light source and directs and distributes the laser light onto the laser-based panel display to render pixels having a reduced spatial coherence and a preserved pixel pitch as a result of at least one of:
an optical path distance between the pixels being greater than a coherent length of the laser light;
incoherent addition of light from at least one of multiple ports or multiple sources;
active modulation of the laser light; or
quasi-random placement of outcoupling elements.

20. A system comprising:
at least one input configured to receive laser light from a laser light source; and
at least one output configured to direct and distribute the laser light onto a laser-based panel display to render pixels having a reduced spatial coherence and a preserved pixel pitch as a result of at least one of:
an optical path distance between the pixels being greater than a coherent length of the laser light;
incoherent addition of light from at least one of multiple ports or multiple sources;
active modulation of the laser light; or
quasi-random placement of outcoupling elements.
